(19) United States
(12) Patent Application Publication
(10) Pub. No.: US 2026/0175638 A1
(43) Pub. Date: Jun. 25, 2026

(54) AIR SUPPLY INSTALLATION, VEHICLE SYSTEM, MOTOR VEHICLE AND METHOD FOR SUPPLYING AN AIR CONSUMER

(71) Applicant: ZF CV Systems Europe BV, Brussels (BE)

(72) Inventors: Uwe Stabenow, Laatzen (DE); Jörg Meier, Hessisch Oldendorf (DE)

(21) Appl. No.: 19/537,344

(22) Filed: Feb. 11, 2026

Related U.S. Application Data
(63) Continuation of application No. PCT/EP2024/074406, filed on Sep. 2, 2024.

(30) Foreign Application Priority Data
Sep. 18, 2023 (DE) 10 2023 125 146.5

(51) Int. Cl. B60H 1/00; F24F 1/022

(52) U.S. Cl. CPC B60H 1/00371; B60H 1/00328; B60H 1/00535; F24F 1/022; B60H 2001/00178

(57) ABSTRACT

An air supply installation is for a motor vehicle which has an air conditioning installation. The air supply installation is configured to supply at least one air consumer which is separate from the air conditioning installation. The air supply installation has an intake opening for suctioning in air, a compressor for compressing the suctioned-in air and a condensation cooler which is fluidically connected to the compressor. The condensation cooler is arranged in a cold-air region of the air conditioning installation.

### CROSS-REFERENCE TO RELATED APPLICATIONS

This application is a continuation application of international patent application PCT/EP2024/074406, filed Sep. 2, 2024, designating the United States and claiming priority from German application 10 2023 125 146.5, filed Sep. 18, 2023, and the entire content of both applications is incorporated herein by reference.

### TECHNICAL FIELD

The disclosure relates to an air supply installation for supplying at least one air consumer of a motor vehicle. The disclosure relates in particular to such an air supply installation which is set up to compress the suctioned-in air and to reduce a quantity of water in the suctioned-in air before the suctioned-in and compressed is supplied to the air consumer. The disclosure also relates to a vehicle system and a motor vehicle including such an air supply installation and to methods which can be carried out with such an air supply installation.

### BACKGROUND

Air supply installations are used in motor vehicles to supply air to air consumers, such as brake cylinders, air springs or other components of pneumatic vehicle systems.

DE 10 2020 119 792 A1 and DE 20 2004 002 910 U1 disclose air supply installations in which air is suctioned in from a cold region of an air conditioning installation. The suctioned-in air can be supplied to an air dryer. The suctioning-in of air from the cold region reduces environmental influences.

An efficient drying of the suctioned-in air is desirable. As explained in DE 10 2020 119 792 A1, the suctioning-in of air from the cold region of the air conditioning installation can extend a regeneration cycle of an air dryer. A further improvement of the drying of suctioned-in air in an air supply installation is desirable, for example for an even further extension of the running time of an air dryer until a renewed regeneration.

### SUMMARY

It is an object of the disclosure to provide an improved air supply installation and an improved method, which makes it possible to dehumidify suctioned-in air efficiently.

The object is achieved by an air supply installation, a vehicle system, a motor vehicle and methods according to various embodiments of the disclosure.

According to an aspect of the disclosure, an air supply installation is specified for a motor vehicle which has an air conditioning installation. The air supply installation is configured to supply at least one air consumer which is separate from the air conditioning installation. The air supply installation has: an intake opening for suctioning in air, a compressor for compressing the suctioned-in air and a condensation cooler which is fluidically connected to the compressor. The condensation cooler is located in a cold-air region of the air conditioning installation.

Via a condensation cooler arranged in the cold-air region of the air conditioning installation, a particularly efficient dehumidification of the air to be supplied to the at least one air consumer can be achieved. The air supply installation makes use of the fact that an efficiency of the condensation cooler depends on an ambient temperature of the condensation cooler. By positioning the condensation cooler in the cold-air region, the dehumidification of the air to be supplied to at least one air consumer can be particularly efficient.

Advantageously, the condensation cooler may be arranged along an air conditioning installation airflow path extending from an evaporator of the air conditioning installation to a vehicle interior.

This allows the condensation cooler to be positioned in an air conditioning installation airflow that has already been cooled by the evaporator of the air conditioning installation.

Advantageously, the condensation cooler may be arranged such that cold air generated by the evaporator flows around or through the condensation cooler.

This enables particularly efficient dehumidification by the condensation cooler. In particular, the efficiency of the condensation cooler is high when the cold air of the air conditioning installation flows around or through the condensation cooler.

Advantageously, the condensation cooler may be set up to dehumidify an input airflow of the condensation cooler to provide an output airflow of the condensation cooler.

This means that the air to be supplied to at least one air consumer can be cooled and dehumidified via a condensation cooler coolant circuit. The condensation cooler coolant circuit may include a condensation cooler condenser and a condensation cooler compressor in a known manner, wherein the condensation cooler condenser is fluidically connected to the condensation cooler evaporator via a valve.

The air supply installation may include an adsorption dryer that is set up to further dehumidify the output airflow of the condensation cooler.

This allows for multi-stage dehumidification in the air supply installation. The dehumidification already carried out by the condensation cooler as the first dehumidification stage makes it possible to size the dehumidification tank used for further dehumidification in a second dehumidification stage more compactly and/or to extend its runtime until a new regeneration.

Advantageously, the condensation cooler may be arranged along the air conditioning installation airflow path between the evaporator and a heater of the air conditioning installation.

This allows the condensation cooler to be positioned in the air conditioning installation airflow path so that air that has not yet passed through the heater flows around or through the condensation cooler.

Alternatively, the condensation cooler may be arranged so that, along the air conditioning installation airflow path, it is downstream of the evaporator and a heater of the air conditioning installation.

This will also allow for an arrangement of the condensation cooler downstream (in relation to the air conditioning installation airflow path toward the vehicle interior) of the heater. This can be advantageous, for example, for space reasons.

Advantageously, the condensation cooler may be arranged in an evaporator box of the air conditioning installation.

This enables particularly efficient dehumidification by the condensation cooler. In particular, the efficiency of the condensation cooler is high when cold air that has already passed through the evaporator of the air conditioning installation flows around or through the condensation cooler in the evaporator box.

Advantageously, the air supply installation may further include at least one pneumatic arrangement for conducting an output airflow of the condensation cooler to the at least one air consumer.

This means that the output airflow of the condensation cooler dehumidified by the condensation cooler can be forwarded to at least one air consumer.

The pneumatic arrangement may include at least one compressed gas tank and one or more controllable valves (in particular at least one 2/2-way valve) between the compressed gas tank and the condensation cooler in order to supply the compressed gas tank with the output airflow dehumidified by the condensation cooler. The one or more controllable valves (in particular at least one 2/2-way valve) may alternatively or additionally be provided between the compressed gas tank and the at least one air consumer to supply compressed gas from the compressed gas tank to at least one air consumer. The pneumatic arrangement may have fluidic connections between the mentioned components.

This means that the dehumidified and cooled air can be stored in the compressed gas tank and, if necessary, forwarded in a controlled manner, for example under the control of a control system, to at least one air consumer.

Advantageously, the condensation cooler may be arranged along an air supply installation flow path (which extends from the intake opening to the air consumer) between the compressor and the at least one air consumer.

This allows the suctioned-in air compressed, and thus heated, by the compressor to be cooled and dehumidified in the condensation cooler. The disclosed advantages of the arrangement of the condensation cooler in the cold-air region of the air conditioning installation can be achieved for a condensation cooler in a compressor path of the air supply installation. The compaction increases the absolute humidity of the compressed air. Since the air compression by the compressor simultaneously leads to a significant increase in the temperature of the compressed air, the relative humidity, on the other hand, does not increase or does not increase significantly. Depending on the temperature increase, there may even be a reduction in relative humidity due to the compression. This prevents water from condensing as long as the temperature of the compressed air is sufficiently high. The arrangement of the condensation cooler allows efficient dehumidification.

Alternatively, the condensation cooler may be arranged along an air supply installation flow path (which extends from the intake opening to the air consumer) between the intake opening and the compressor.

The disclosed advantages of the arrangement of the condensation cooler in the cold-air region of the air conditioning installation can be achieved for a condensation cooler in the suction path of the air supply installation.

A vehicle system according to a further aspect of the disclosure includes at least one air consumer and the air supply installation according to an aspect or embodiment of the disclosure for supplying the at least one air consumer.

The technical effects achieved by the vehicle system correspond to the technical effects explained with reference to the air supply installation. In particular, efficient dehumidification of the air to be supplied to the air consumer is achieved.

Advantageously, the vehicle system may include a sensor cleaning system, an air suspension system, a brake system, a gear shift system, a door seal system, a pneumatic locking system and/or a tire filling system.

Thus, the efficient dehumidification, which is achieved by the air supply installation according to embodiments, can be used for air consumers in which the use of dehumidified air is advantageous, for example with regard to their service life and/or to achieve an efficient sensor cleaning.

Advantageously, the vehicle system may include a vehicle sensor.

Thus, the efficient dehumidification, which is achieved by the air supply installation according to embodiments, can be used for an efficient sensor cleaning, wherein the application of moisture to the vehicle sensor is reduced due to the dehumidification.

Advantageously, the vehicle system can be configured to generate a directed cleaning airflow for cleaning the vehicle sensor.

Thus, the efficient dehumidification, which is achieved by the air supply installation according to embodiments, can be used for an efficient sensor cleaning, wherein the application of moisture to the vehicle sensor is reduced due to the dehumidification.

Advantageously, the vehicle system may further include an electronic control system, which is coupled with an output of the vehicle sensor. The electronic control system can be set up for controlling at least one controllable vehicle component.

Thus, the efficient dehumidification achieved by the air supply installation according to embodiments can be used in the context of sensor-based driver assistance systems and/or autonomous driving systems.

Advantageously, the vehicle system may also include the air conditioning installation.

This will achieve the advantages explained in the context of the air supply installation.

Advantageously, the condensation cooler of the air supply installation can be arranged in an evaporator box of the air conditioning installation.

This enables particularly efficient dehumidification by the condensation cooler. In particular, the efficiency of the condensation cooler is high when cold air that has already passed through the evaporator of the air conditioning installation flows around or through the condensation cooler in the evaporator box.

A motor vehicle according to another aspect of the disclosure includes the air supply installation or the vehicle system according to an aspect or embodiment of the disclosure.

According to a further aspect of the disclosure, a method for supplying at least one air consumer by an air supply installation of a motor vehicle is specified, wherein the motor vehicle has an air conditioning installation, and wherein the at least one air consumer supplied by the air supply installation is separate from the air conditioning installation. The method includes: compressing the suctioned-in air by a compressor of the air supply installation and cooling and dehumidifying the suctioned-in air by a condensation cooler of the air supply installation which is fluidically connected to the compressor, wherein the condensation cooler is located in a cold-air region of the air conditioning installation.

According to a further aspect of the disclosure, a method for reducing an energy consumption of an air supply installation of a motor vehicle is specified, wherein the motor vehicle has at least one air consumer. The method includes supplying the at least one air consumer by the method for supplying at least one air consumer.

According to a further aspect of the disclosure, a method for increasing a range of a motor vehicle, in particular an electric motor vehicle, is also specified, which has a reduction of an energy consumption of an air supply installation by the method for reducing the energy consumption.

Advantageously, the methods can be carried out in each case with the air supply installation according to an embodiment of the disclosure, the vehicle system according to an embodiment of the disclosure or the motor vehicle according to an embodiment of the disclosure.

### BRIEF DESCRIPTION OF DRAWINGS

The invention will now be described with reference to the drawings wherein:

FIG. 1 shows a motor vehicle having a vehicle system according to an embodiment in which a condensation cooler is arranged in a compressor path of an air supply installation.

FIG. 2 shows a motor vehicle having a vehicle system according to a further embodiment, in which a condensation cooler is arranged in a suction path of an air supply installation.

FIG. 3 shows an arrangement of the condensation cooler of the vehicle system of FIG. 1 and FIG. 2 according to an embodiment.

FIG. 4 shows a further arrangement of the condensation cooler of the vehicle system of FIG. 1 and FIG. 2 according to a further embodiment.

FIG. 5 shows schematically an embodiment of the condensation cooler of an air supply installation and a vehicle system according to an embodiment.

FIG. 6 shows schematically a configuration of the condensation cooler of an air supply installation and a vehicle system according to a further embodiment.

FIG. 7 shows an embodiment of a vehicle system including an air supply installation.

FIG. 8 shows another embodiment of a vehicle system including an air supply installation.

FIG. 9 shows a motor vehicle having a vehicle system according to an embodiment including a sensor cleaning system.

FIG. 10 shows a motor vehicle having a vehicle system according to an embodiment including an air suspension system.

FIG. 11 shows a motor vehicle having a vehicle system according to an embodiment including a pneumatic brake system.

FIG. 12 shows a motor vehicle having a vehicle system according to an embodiment including a pneumatic sealing system.

FIG. 13 shows a motor vehicle having a vehicle system according to an embodiment including a pneumatic gear shift system.

FIG. 14 shows a motor vehicle having a vehicle system according to an embodiment including a pneumatic locking system.

FIG. 15 shows a motor vehicle having a vehicle system according to an embodiment including a tire filling system.

FIG. 16 shows a motor vehicle having a vehicle system according to an embodiment including an electrically regenerable dehumidification tank.

FIG. 17 shows runtimes of dehumidification tanks for an air supply installation according to an embodiment of the disclosure in comparison to an air supply installation not according to the disclosure.

FIG. 18 is a flowchart of a method according to an embodiment.

### DETAILED DESCRIPTION

The invention, which is described in detail below with reference to embodiments shown in the figures, provides in a technically advantageous manner a certain arrangement of a condensation cooler of an air supply installation with respect to components of an air conditioning installation. In order to distinguish between different pneumatic paths, airflows in the air conditioning installation are referred to in this application as air conditioning installation airflows, unless it is apparent from the context (in particular from the reference signs used) that the airflow is in the air conditioning installation. Similarly, components of the air conditioning installation, such as a compressor or an evaporator of the air conditioning installation, are referred to as air conditioning installation compressor and air conditioning installation evaporator, unless it is apparent from the context (in particular from the references used) that they are the corresponding components of the air conditioning installation.

Even if, for reasons of clarity, only one air consumer is represented in some of the figures, the air supply installation may be set up for the use of several air consumers. The air supply installation may be set up and installed to supply exactly one or more air consumers.

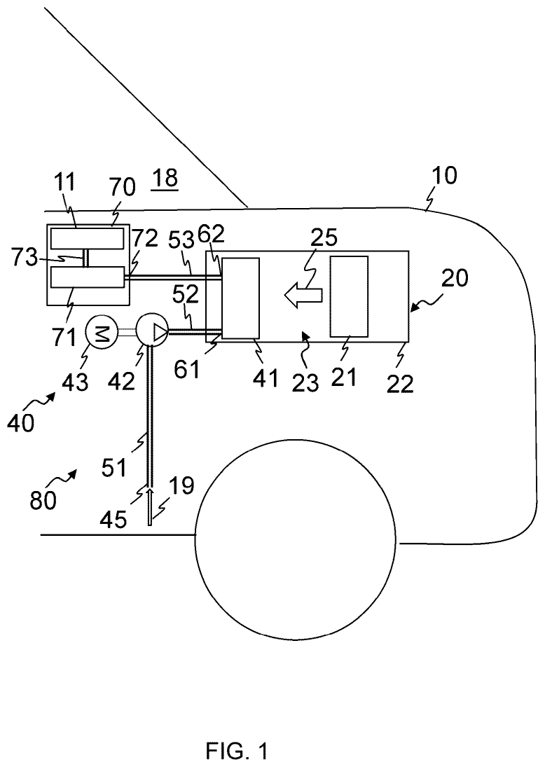

FIG. 1 shows a motor vehicle 10 which has a vehicle system 80. The vehicle system 80 has at least one air consumer 11, an air supply installation 40 for supplying the at least one air consumer 11 and an air conditioning installation 20.

The air conditioning installation 20 has an air conditioning installation evaporator 21, which is arranged in an evaporator box 22. The air conditioning installation 20 is configured to transport air along an air conditioning installation airflow path 23 into a vehicle interior 18. The air conditioning installation 20 is set up such that cooled air from the air conditioning installation evaporator 21 flows as cold airflow 25 in a cold region of the air conditioning installation airflow path 23, which is located along the air conditioning installation airflow path 23 downstream of the evaporator 21, toward a vehicle interior 18.

The air supply installation 40 has an intake opening 45, a compressor 42 for compressing the suctioned-in air via the intake opening 45 and a condensation cooler 41. The condensation cooler 41 is configured to cool and dehumidify an input airflow received at a first condensation cooler connection 61 from the condensation cooler 41 and to output the cooled and dehumidified air at a second condensation cooler connection 62 as an output airflow.

The condensation cooler 41 is positioned in the cold region of the air conditioning installation airflow path 23, which is located along the air conditioning installation airflow path 23 downstream (in relation to the air conditioning installation airflow path 23 toward the vehicle interior 18) of the air conditioning installation evaporator 21. When the air conditioning installation 20 is in operation, the condensation cooler 41 of the air supply installation is thus positioned in the cold airflow 25 of the air conditioning installation. The condensation cooler 41 may be positioned in particular within the evaporator box 22 so that it is arranged along the air conditioning installation airflow path 23 downstream of the evaporator 21. By this arrangement, the dependence of an efficiency of the condensation cooler 41 on an ambient temperature is used in a technically advantageous manner to dehumidify and cool the air to be supplied to the air consumer 11 in an energy-efficient manner.

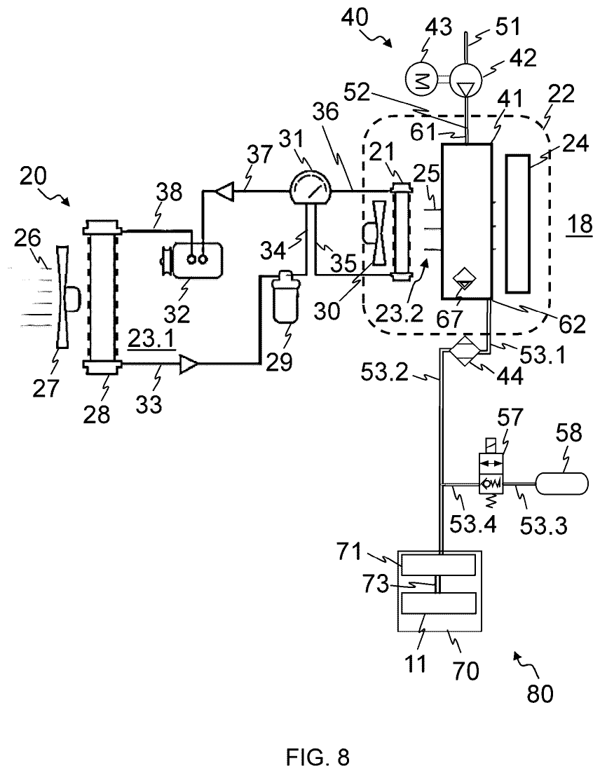

Dehumidification is understood to mean a reduction in the amount of water, wherein the amount of water does not have to be reduced to zero. The amount of water in the output airflow of the condensation cooler 41 at the second condensation cooler connection 62 can be greater than zero. A further reduction of the amount of water can be carried out by an adsorption dryer of the air supply installation, as will be explained in more detail with reference to FIG. 8, for example.

The air supply installation 40 has a compressor 42 for compressing the suctioned-in air 19 and a drive 43 for driving the compressor 42. In the embodiment shown in FIG. 1, the condensation cooler 41 is arranged in a compressor path of the air supply installation 40. The condensation cooler 41 is arranged with respect to an air supply installation flow path downstream of the compressor 42, that is, between the compressor 42 and a gas pressure tank and/or the at least one air consumer 11. The condensation cooler 41 is thus arranged and set up to receive, cool and dehumidify compressed—and thus heated—suctioned-in air from the compressor 42 at the first condensation cooler connection 61 and to output it at the second condensation cooler connection 62.

The air supply installation 40 has a suction line 51 which has the intake opening 45 or is directly connected to it. The suction line 51 is connected to the compressor 42, for example directly connected to the compressor 42, in order to allow compression of the suctioned-in air 19 by the compressor 42. The compressor 42 is connected to the first condensation cooler connection 61 via a first connecting line 52. The first connecting line 52 can be directly connected to both the first compressor 42 and the condensation cooler 41. The second condensation cooler connection 62 is directly connected to a second connecting line 53, which is set up to direct the dehumidified and cooled air provided via the second condensation cooler connection 62 further toward the air consumer 11. The second connecting line 53 may be directly connected to the air consumer 11. However, the second connecting line 53 may also be connected to a compressed air inlet 72 of an air consumer system 70, wherein one or more pneumatic components of a pneumatic system 71 between the compressed air inlet 72 of the air consumer system 70 and the air consumer 11 may be provided. The pneumatic system 71 may in particular include a compressed air tank for storing dehumidified air with the condensation cooler 41 and a 2/2-way valve (for example, a 2/2-way solenoid valve) between the compressed air tank and the condensation cooler 41, as described in more detail with reference to FIG. 8. The pneumatic system 71 may have one or more controllable valves to supply compressed air to the air consumer 11 in a controlled manner. The air supply installation 40 may thus have a pneumatic system 71, which may have a compressed air tank for storing dehumidified air with the condensation cooler 41, a 2/2-way valve and/or one or more other controllable valves to supply the dehumidified air provided by the condensation cooler 41 at the second condensation cooler connection 62 to the air consumer 11. The pneumatic system 71 is directly connected to the second condensation cooler connection 62 via the second connecting line 53. The air consumer 11 is directly connected to the pneumatic system 71 via a supply connection 73. The connecting line 51, the connecting lines 52, 53 and the supply connection 73 may be configured as tubular line elements, as channels in vehicle components or otherwise.

An embodiment as disclosed with reference to FIG. 1 is technically advantageous, since the condensation cooler 41 is set up and arranged to cool again and dehumidify the air already compressed by the compressor 42.

In operation of the vehicle system 80, in an operating state in which the air conditioning installation 20 and the air supply installation 40 are in operation, the suctioned-in air 19 is cooled and dehumidified by the condensation cooler 41 after compression by the compressor 42 in the air supply installation 40. This is done in an energy-efficient manner, since the condensation cooler 41 is positioned so that, at any rate, cold air 25 of the air conditioning installation 20 flows around the condensation cooler, optionally also through it.

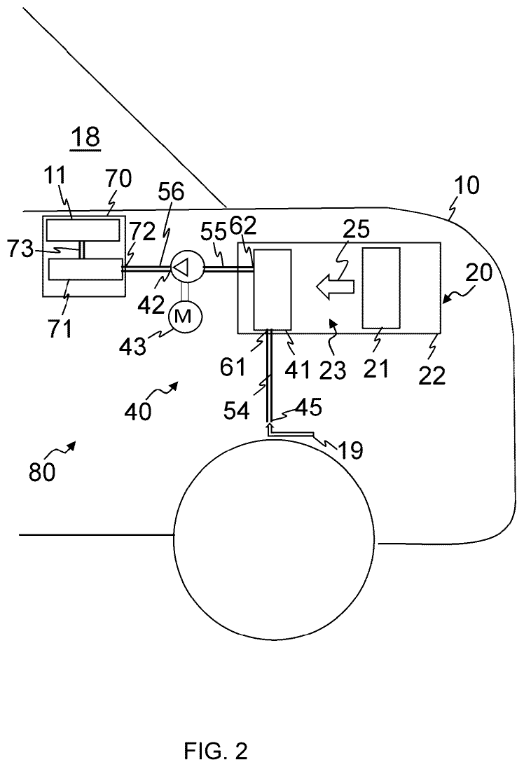

FIG. 2 shows a motor vehicle having a vehicle system 80, which has an air supply installation 40 according to a further embodiment. The air supply installation 40 is set up and arranged such that the condensation cooler 41 is arranged in a suction path of the air supply installation 40. The condensation cooler 41 is arranged with respect to an air supply installation flow path (with flow direction toward the air consumer 11) between the intake opening 45 and the compressor 42. The condensation cooler 41 is thus set up and arranged to receive, cool and dehumidify air 19 suctioned in via the intake opening 45 at the first condensation cooler connection 61 and to output it at the second condensation cooler connection 62 in the direction of the compressor 42. The air supply installation 40 has a suction line 54 which has the intake opening 45 or is directly connected to it. The suction line 54 is connected to the condensation cooler 41, in particular directly connected to it, in order to direct the suctioned-in air 19 to the condensation cooler 41 before its compression.

The second condensation cooler connection 62 is directly connected to a first connecting line 55, which is set up to direct the dehumidified and cooled air provided via the second condensation cooler connection 62 toward the compressor 42 and the air consumer 11. The first connecting line 55 can be directly connected to both the condensation cooler 41 and the first compressor 42. The compressor 42 is connected via a second connecting line to a compressed air inlet 72 of an air consumer system 70. One or more pneumatic components of a pneumatic system 71 may be provided between the compressed air inlet 72 of the air consumer system 70 and the air consumer 11, as explained with reference to FIG. 1.

In operation of the vehicle system 80, in an operating state in which the air conditioning installation 20 is in operation, the suctioned-in air 19 in the air supply installation 40 is cooled and dehumidified by the condensation cooler 41 before it is compressed by the compressor 42. This is done in an energy-efficient manner, since the condensation cooler 41 is positioned so that, at any rate, cold air 25 of the air conditioning installation 20 flows around the condensation cooler, optionally also through it.

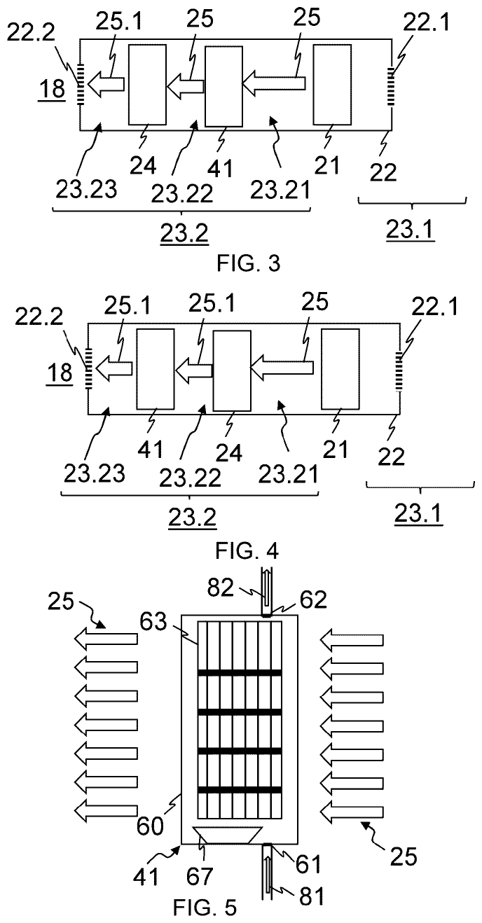

FIG. 3 and FIG. 4 show arrangements of the condensation cooler 41 in the evaporator box 22, as they can be used in each of the air supply installations 40 disclosed here. The air conditioning installation 20 has an air conditioning installation flow path 23 with a first portion 23.1 and a second portion 23.2, wherein, with respect to the air conditioning installation flow path 23 (with respect to a flow direction toward the vehicle interior 18), the first portion 23.1 is arranged upstream of the air conditioning installation evaporator 21 and the second portion 23.2 is arranged downstream of the air conditioning installation evaporator 21. The evaporator box 22, also known in the field as the air conditioning box, has an evaporator box inlet 22.1 and an evaporator box outlet 22.2. The air conditioning installation 20 is set up and arranged to supply an air conditioning installation airflow 25.1 cooled in any case by the air conditioning installation evaporator 21 to the vehicle interior 18 via the evaporator box outlet 22.2.

In operation of the air conditioning installation 20, the air conditioning installation evaporator 21 provides a cold airflow 25. This can be heated by a heater 24 of the air conditioning installation in order to generate a temperature-controlled cold airflow 25.1.

FIG. 3 shows an arrangement which can be used in each of the air supply installations 40 disclosed herein, wherein the condensation cooler 41 is positioned along the air conditioning installation flow path 23 between the air conditioning installation evaporator 21 and the heater 24. Such an arrangement is technically advantageous, since the condensation cooler 41 is arranged in the flow of cold air 25 and thus has a good efficiency even when the heater 24 heats the cold air 25, a temperature of the temperature-controlled cold air 25.1 is thus higher than a temperature of the cold air 25. The second portion 23.2 of the air conditioning installation flow path 23.2 includes a first part 23.21 between the air conditioning installation evaporator 21 and the condensation cooler 41, a second part 23.22 between the condensation cooler 41 and the heater 24, and a third part 23.23 downstream of the heater 24 (with respect to the air conditioning installation flow path 23 toward the vehicle interior 18). The condensation cooler 41 is positioned so that it is positioned between the first and second parts 23.21, 23.22 of the air conditioning installation flow path 23 transporting cold air 25 and so that the cold air 25 flows around it and/or through it during operation of the air conditioning installation. The temperature of cold air 25 changes along the air conditioning installation flow path 23 and is slightly higher in the second part 23.22 than in the first part 23.21. This does not preclude the effects disclosed herein.

FIG. 4 shows an arrangement which can be used in each of the air supply installations 40 disclosed herein, wherein the condensation cooler 41 is positioned along the air conditioning installation flow path 23 downstream of both the air conditioning installation evaporator 21 and the heater 24. Such an arrangement has the technical effect that the condensation cooler 41 has at least a good efficiency when a temperature of the temperature-controlled cold air 25.1 is lower than an ambient air temperature. The second portion 23.2 of the air conditioning installation flow path 23.2 includes a first part 23.21 between the air conditioning installation evaporator 21 and the heater 24, a second part 23.22 between the heater 24 and the condensation cooler 41, and a third part 23.23 downstream of the condensation cooler 41 (with respect to the air conditioning installation flow path 23 toward the vehicle interior). The condensation cooler 41 is positioned so that it is positioned between the second and third parts 23.22, 23.23 of the air conditioning installation flow path 23, which are passed through by temperature-controlled cold air 25.1, and so that the temperature-controlled cold air 25.1 flows around it and/or through it during operation of the air conditioning installation. The temperature of cold air 25 changes along the air conditioning installation flow path 23 and is higher in the third part 23.23 than in the second part 23.22. Despite this fact, the effects disclosed here can still be achieved.

FIG. 5 shows a schematic representation of the condensation cooler 41 for explaining an implementation of the condensation cooler 41, as it can be used in each of the air supply installations 40 disclosed herein. The condensation cooler 41 is configured as a passive condensation cooler.

The condensation cooler 41 has the first condensation cooler connection 61 for receiving air to be cooled and dehumidified and the second condensation cooler connection 62 for dispensing the cooled and dehumidified air in the direction of the air consumer 11. The condensation cooler 41 has at least one condensation surface 63. The at least one condensation surface 63 may be arranged in a housing 60, which includes the first condensation cooler connection 61 and the second condensation cooler connection 62. The condensation cooler 41 is configured to lower the temperature of a condensation cooler inlet airflow 81 so that water from the condensation cooler inlet airflow 81 condenses on at least one condensation surface 63. The cooled and dehumidified air can be output via the second condensation cooler connection 62 as the condensation cooler output airflow 82 in the direction of the air consumer 11.

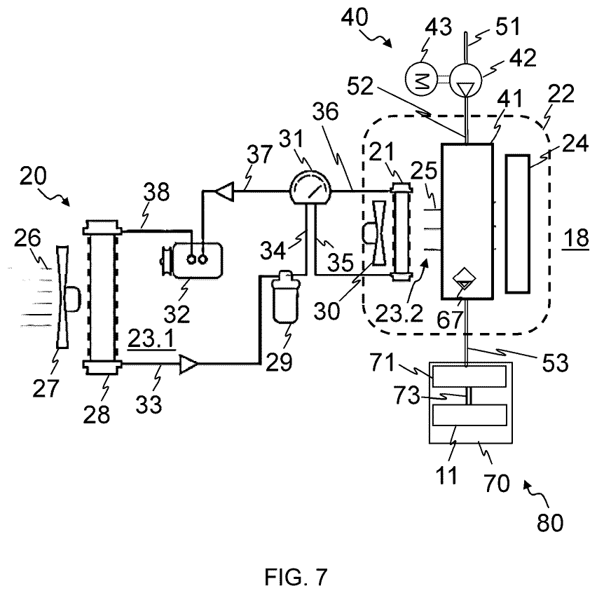

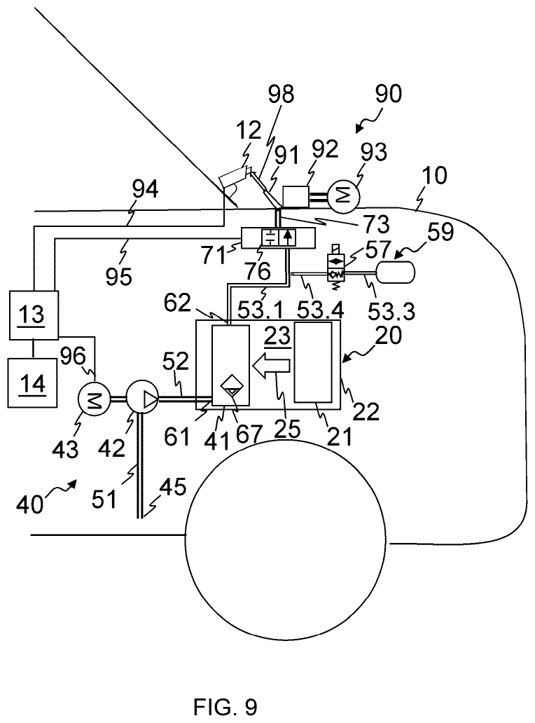

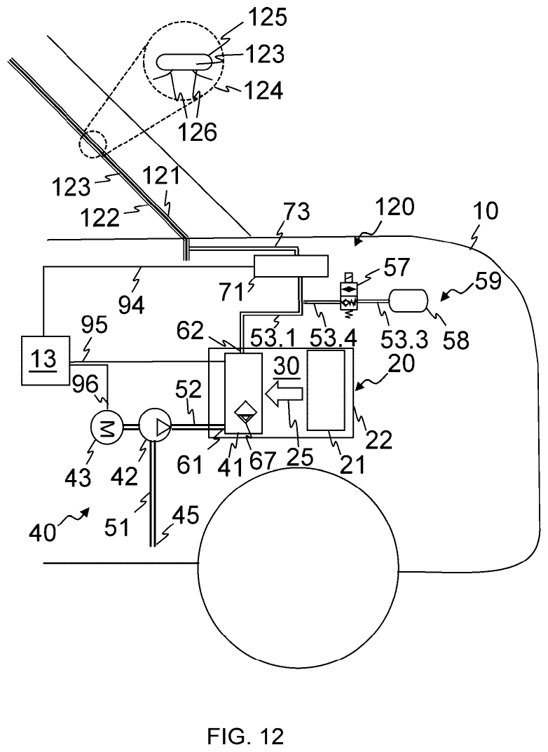

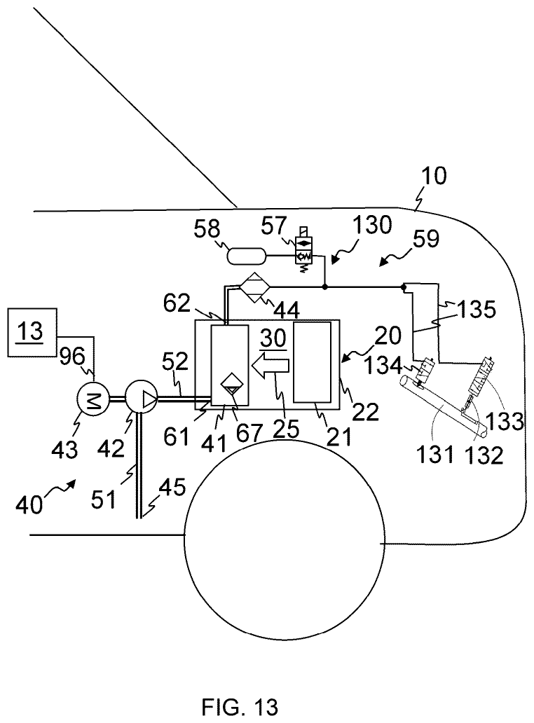

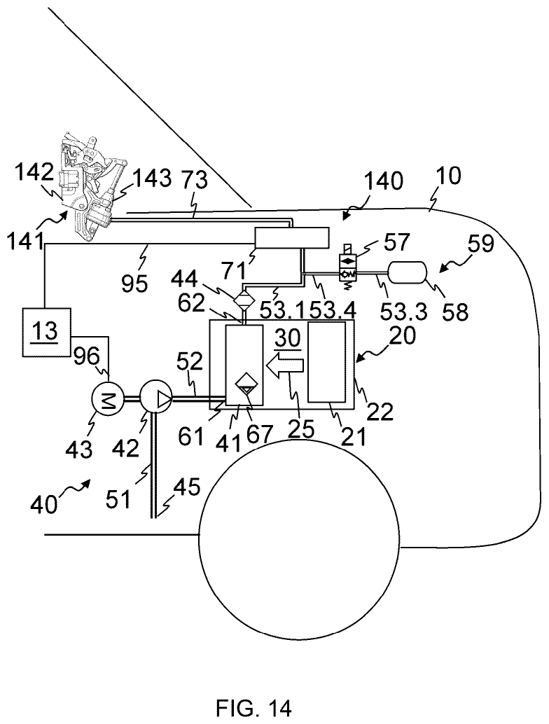

The condensation cooler 41 has a water collecting tank 67 for collecting water condensed on at least one condensation surface 63. The water collecting tank 67 can be configured as a water collecting tank with a water removal device 67, as shown in FIG. 7, FIG. 8, FIG. 9, FIG. 12, FIG. 13, FIG. 14 and FIG. 16. This allows the collected amounts of condensed water to be discharged.

As explained, the condensation cooler 41 is positioned so that the cold air 25 or the temperature-controlled cold air 25.1 of the air conditioning installation flows around and/or through the condensation cooler. The efficiency of the condensation cooler 41 is thereby increased, in particular in comparison to an arrangement in which the condensation cooler 41 is surrounded by ambient air with a temperature higher than the temperature of the cold air 25 or the temperature-controlled cold air 25.1.

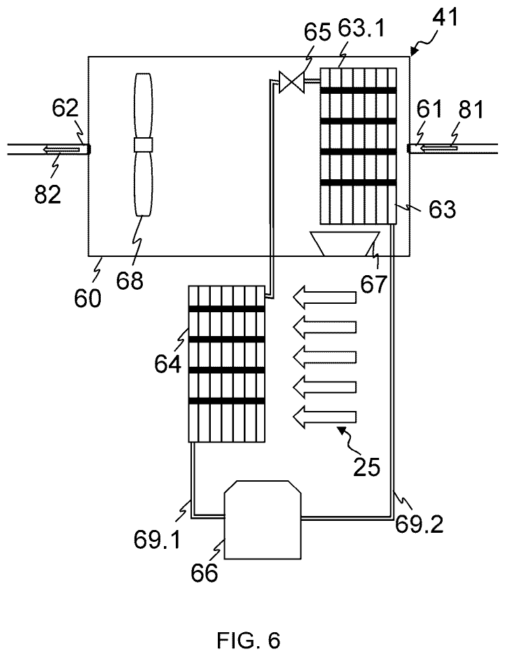

FIG. 6 shows a schematic representation of the condensation cooler 41 for explaining an implementation of the condensation cooler 41, as it can be used in each of the air supply installations 40 disclosed herein. The condensation cooler 41 is configured as an active condensation cooler.

The condensation cooler 41 has the first condensation cooler connection 61 for receiving air to be cooled and dehumidified and the second condensation cooler connection 62 for dispensing the cooled and dehumidified air in the direction of the air consumer 11. The condensation cooler 41 has a condensation cooler coolant circuit including a condensation cooler evaporator 63.1, an overflow valve 65 (which may be configured as a regulating valve), a condensation cooler condenser 64 and a condensation cooler compressor 66. The condensation cooler 41 also has condensation cooler lines, which have a first condensation cooler lines 69.1 connecting the condensation cooler condenser 64 to the condensation cooler compressor 66 and a second condensation cooler lines 69.2 connecting the condensation cooler compressor 66 to the condensation cooler evaporator 63.1. The condensation cooler 41 has a water collecting tank 67 for collecting water condensed on the condensation surface 63, for example, an outer surface of the condensation cooler evaporator 63.1. The water collecting tank 67 can be configured as a water collecting tank with a water removal device 67, as shown in FIG. 7, FIG. 8, FIG. 9, FIG. 12, FIG. 13, FIG. 14 and FIG. 16. This allows the collected amounts of condensed water to be discharged.

During the operation of the condensation cooler, the condensation cooler compressor 66 liquefies a condensation cooler coolant. The liquid condensation cooler coolant evaporates in the condensation cooler evaporator 63.1, wherein a condensation cooler inlet airflow 81 which passes over the condensation cooler evaporator 63.1 is cooled and water from the condensation cooler inlet airflow 81 condenses on the outer surface of the condensation cooler evaporator 63.1. The cooled and dehumidified air can be conveyed under the influence of a fan 68 to the second condensation cooler connection 62 and output via the second condensation cooler connection 62 as a condensation cooler output airflow 82 in the direction of the air consumer 11 and/or an optionally available gas pressure tank. The condensation cooler 41 has a housing 60 which includes the first condensation cooler connection 61 and the second condensation cooler connection 62. The housing 60 can define a flow path that directs the condensation cooler inlet airflow 81 past the outer surface of the condensation cooler evaporator 63.1 to ensure cooling and dehumidification of this airflow.

The condensation cooler 41 is positioned so that the cold air 25 or the temperature-controlled cold air 25.1 of the air conditioning installation flows around or through the condensation cooler condenser 64. The efficiency of the condensation cooler 41 is thereby increased, in particular in comparison to an arrangement in which the condensation cooler 41 is surrounded by ambient air with a temperature higher than the temperature of the cold air 25 or the temperature-controlled cold air 25.1.

FIG. 7 shows a vehicle system 80 in accordance with a further embodiment. The air supply installation 40 of the vehicle system 80 may have the already explained configuration. The condensation cooler 41 may be formed in accordance with the illustration in FIG. 5 and is shown in a simplified form. FIG. 7 shows additional features of the air conditioning installation 20 of the vehicle system 80.

The air conditioning installation 80 has an air conditioning installation coolant circuit including an air conditioning installation compressor 32, air conditioning installation condenser 28, air conditioning installation dehumidification tank 29, air conditioning installation regulating valve 31 and the evaporator 21. The air conditioning installation coolant circuit includes a plurality of air conditioning installation coolant lines that connect the stated components, in particular: a first air conditioning installation coolant line 33 connecting the air conditioning installation condenser 28 to the air conditioning installation dehumidification tank 29, a second air conditioning installation coolant line 34 connecting the air conditioning installation dehumidification tank 29 to the air conditioning installation regulating valve 31, a third air conditioning installation coolant line 35, and a fourth air conditioning installation coolant line 36, each connecting the air conditioning installation regulating valve 31 to the evaporator 21, a fifth air conditioning installation coolant line 37 connecting the air conditioning installation regulating valve 31 to the air conditioning installation compressor 32, and a sixth air conditioning installation coolant line 38 connecting the air conditioning installation compressor 32 to the air conditioning installation condenser 28. For inducing and/or conveying the air conditioning installation airflow at low driving speed or when the motor vehicle is stationary, the air conditioning installation 20 may include an air conditioning installation fan 27 which is set up to convey an air conditioning installation inlet airflow 26 from a vehicle environment toward the air conditioning installation condenser 28. In the air conditioning installation 20, the conveyed air moves along the first portion 23.1 of the air conditioning installation flow path from the air conditioning installation condenser 28 to the evaporator 21. The air conditioning installation 20 has a further air conditioning installation fan 30 in order to convey the air conditioning installation airflow along the evaporator 21 to generate the cold airflow 25, which cools the condensation cooler 41 of the air supply installation 40 in the evaporator box 22 of the air conditioning installation 20, before continuing to flow toward the vehicle interior 18.

The air supply installation 40 is configured such that the compressed air compressed by the compressor 42 is supplied via the first connecting line 52 to the condensation cooler 41, around which or through which the cold air 25 flows. The cooling of the compressed air causes water to condense out and thus causes the compressed air to dry. The air supply installation 40 is configured such that the dried compressed air is supplied to the pneumatic system 71 via the second connecting line 53.

FIG. 8 shows a further embodiment of the vehicle system 80, in particular further components and features of the air supply installation 40 are explained. These components and features of the air supply installation 40 can be used not only in the air supply installation 40 of FIG. 8, but also in all other air supply installations 40 disclosed herein.

The air supply installation 40 has an adsorption dryer 44 for further reducing a quantity of water in the condensation cooler output airflow 82 of the condensation cooler 41. The adsorption dryer 44 is connected via a second connecting line 53.1 to the second condensation cooler connection 62 to receive the condensation cooler output airflow 82 of the condensation cooler 41. The adsorption dryer 44 is directly connected to the pneumatic system 71 via a third connecting line 53.2. As already explained, one or more controllable valves of the pneumatic system 71 and a controllable 2/2-way valve 57 can supply the air dehumidified by the condensation tank 41 in a controlled manner from a compressed gas tank 58 to the air consumer 11. The compressed gas tank can temporarily store the dehumidified air provided by the condensation cooler 41 and the adsorption dryer 44.

The air supply installation 40 may be set up to temporarily store the dehumidified and cooled air before it is supplied to the air consumer 11. For this purpose, the air supply installation 40 may include a gas tank, for example the compressed gas tank 58, and the 2/2-way valve 57 (for example, a 2/2-way solenoid valve) or another controllable valve. The 2/2-way valve 57 is directly connected to the compressed air tank 58 via a fourth connecting line 53.5. The 2/2-way valve is fluidically connected to the third connecting line 53.2 via a fifth connecting line 53.4. The adsorption dryer 44 is connected to the 2/2-way valve 53.2 via a part of the third connecting line 53.2 and a third connecting line 57. The 2/2-way valve 57 can be controlled to selectively store dehumidified compressed air from the third connecting line 53.2 in the compressed air tank 58. The 2/2-way valve 57 is controllable to supply compressed air from the compressed air tank 58 to the pneumatic system 71 in order to provide it to the air consumer 11.

The air supply installation 40 can be configured and set up to supply different types of air consumers. With reference to FIG. 9 to FIG. 15, different embodiments of the vehicle system 80 are described, each having different types of air consumers. The air supply installation 40 may be configured to supply several different types of air consumers of the same motor vehicle with air dehumidified by the condensation cooler 41. Thus, the two or more than two different types of air consumers, which are described with reference to FIG. 9 to FIG. 15, may be provided in the same vehicle system 80, wherein the air supply installation 40 provides dehumidified air for supplying the different types of air consumers.

FIG. 9 is a schematic representation of a vehicle system including a sensor cleaning system 90. The motor vehicle has at least one sensor 12. The at least one sensor 12 may include an image sensor or another type of sensor, for example, a sensor that measures in a contact-free manner using electromagnetic radiation, for example, a distance sensor. The motor vehicle 10 has a control system 13, which is connected via a transmission path 94, for example a digital or analog signal line or a vehicle bus, to the at least one sensor for communication. The control system 13 is set up to control one or more controllable vehicle component(s) 14, depending on the information detected with the at least one sensor 12. The controllable vehicle component(s) 14 may include a man-machine interface and/or vehicle actuators. The control system 13 may be set up to perform at least one driver assistance function or an autonomous driving function depending on the information detected with the at least one sensor 12 and to control the controllable vehicle component(s) 14 accordingly based on the information detected with the at least one sensor 12.

The sensor cleaning system 90 has at least one nozzle 91 as an air consumer. The nozzle 91 is set up to output a directed cleaning airflow 98 for cleaning the at least one sensor 12. The directed cleaning airflow 98 may have a sequence of compressed air pulses. For generating the directed cleaning airflow 98, the control system 13 can be set up to control at least one controllable valve (for example, a controllable 2/2-way valve 76) of the pneumatic system 57 and/or the controllable 2/2-way valve 71 to selectively supply the nozzle 91 with compressed air from the compressed gas tank 58. The control can be carried out automatically, for example in response to a contamination of at least one sensor 12, which is detectable based on the information detected with the at least one sensor 12, and/or based on a time elapsed since a last sensor cleaning. For controlling the at least one controllable valve (for example, the controllable 2/2-way valve 76) of the pneumatic system 57 and/or the controllable 2/2-way valve 71, the control system is coupled to the pneumatic system 71 via a transmission path 95, for example a digital or analog signal line or a vehicle bus.

The control system 13 can be set up to control the drive 43 of the compressor 42. For this purpose, the control system 13 can be connected to the drive 42 via a transmission path 96, for example a digital or analog signal line or a vehicle bus. The control system 13 can be set up to control the drive 43 depending on an operating state of the air conditioning installation 20, depending on a pressure in the compressed gas tank 58 and/or depending on a characteristic of the at least one sensor 12 relevant. For example, the control system 13 may be set up to control the drive 43 in order to convey dehumidified and cooled gas into the compressed gas tank 58 if the pressure in the compressed gas tank 58 meets a first criterion (for example, less than a pressure threshold value) and the characteristic of at least one sensor 12 meets a second criterion (for example, a contamination of at least one sensor has been detected, so that cleaning has to be carried out, and/or if the time elapsed since the last sensor cleaning exceeds a time threshold). If the condensation cooler 41 is configured as an active condensation cooler (as shown, for example, in FIG. 6), the control system 13 can be set up to control the condensation cooler 41. Such an activation can also be carried out, for example, depending on the operating state of the air conditioning installation 20, depending on the pressure in the compressed gas tank 58 and/or depending on the characteristic of at least one sensor 12.

The functions of the control system 13 described here can be located in one or several control devices. The control system 13 can be configured as a distributed control system, which has several control devices to perform the functions described here.

The sensor cleaning system 90 may be set up to change a relative position and/or relative alignment of at least one sensor 12 relative to the nozzle 91, when cleaning is to be carried out. To do this, the relative position and/or relative orientation can be changed selectively to perform the cleaning. The sensor cleaning system 90 may include an actuator 92 having a drive 93. The actuator 92 can be controlled by the control system 13 in order to change the relative position and/or relative alignment of at least one sensor 12 relative to the nozzle 91 so that a sensor surface to be cleaned is positioned for cleaning in the directed cleaning airflow 98.

The air supply installation 40 can be a dedicated air supply installation only for supplying air consumers of the sensor cleaning system 90. Alternatively, other types of air consumers separate from the air conditioning installation 20 can be supplied with dehumidified compressed air from the air supply installation 40.

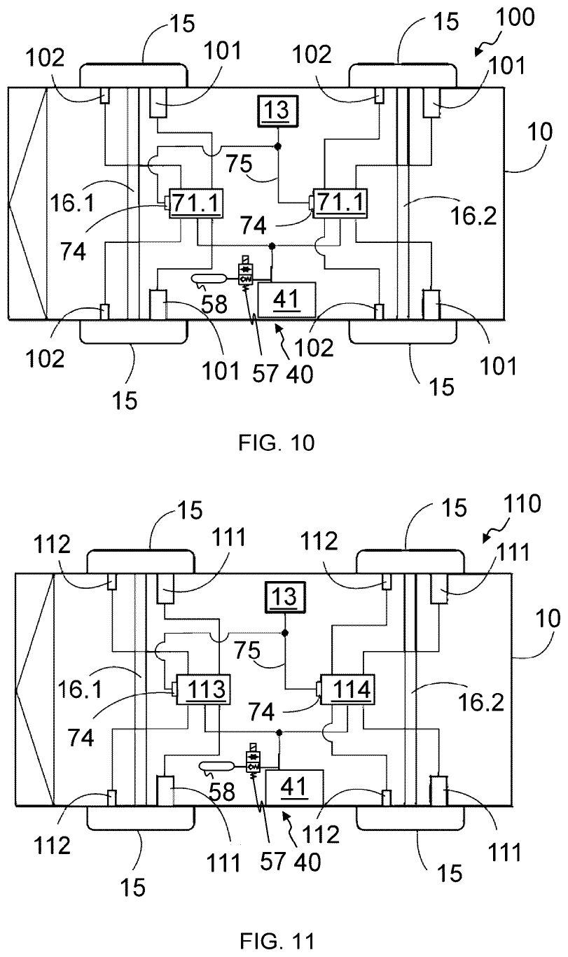

FIG. 10 is a schematic representation of a vehicle system including an air suspension system 100. The air suspension system 100 has air springs 101 on wheels 15 of a front axle 16.1 and a rear axle 16.2 of the motor vehicle 10. The air suspension system 100 has travel sensors 102 on the wheels 15 of the motor vehicle 10.

The air suspension system 100 includes the air supply installation 40, which may include each of the embodiments disclosed herein. In particular, the air supply installation 40 in addition to the condensation cooler 41 arranged in the evaporator box of the air conditioning installation may also include the adsorption dryer 44 in order to further dehumidify air dehumidified by the condensation cooler 41. The condensation cooler 41, as already described, advantageously includes a water collecting tank with a water removal device.

A supply of cooled and dehumidified gas generated by the air supply installation 40, which can be temporarily stored in the compressed gas tank 58, to the air consumers configured as air springs 101 can be carried out in different ways. For example, the air suspension system 100 may include one or more pneumatic systems configured as pneumatic modules 71.1, each having a data interface 74 for connecting to the control 13 of the motor vehicle 10 (for example via a vehicle bus or another transmission path 75) and an interface for connection to the travel sensors 102. Depending on an output signal of the travel sensors 102 and/or depending on control commands of the control system 13, the air springs 101 can be selectively supplied with compressed air from the air supply installation 40 via the pneumatic modules 71.1 or vented via the pneumatic modules 71.1.

FIG. 11 is a schematic representation of a vehicle system including a pneumatic brake system 110. The pneumatic brake system 110 has brake cylinder 110 on wheels 15 of a front axle 16.1 and a rear axle 16.2 of the motor vehicle 10. The brake system 110 has wheel speed sensors 112 on wheels 15 of the motor vehicle 10.

The brake system 110 includes the air supply installation 40, which may include each of the embodiments disclosed herein. In particular, the air supply installation 40 in addition to the condensation cooler 41 arranged in the evaporator box 22 of the air conditioning installation 20 may include the adsorption dryer 44 in order to further dehumidify air dehumidified by the condensation cooler 41. The condensation cooler 41, as already described, advantageously includes a water collecting tank with a water removal device.

A supply of cooled and dehumidified gas generated by the air supply installation 40, which can be temporarily stored in the compressed gas tank 58, to the air consumers configured as brake cylinder 110 can be carried out in different ways. For example, the brake system 110 may include a rear axle modulator 114 and a front axle modulator 113, each having a data interface 74 for connection to the control system 13 of the vehicle 10 (for example via a vehicle bus or another transmission path 75) and an interface for connection to the wheel speed sensors 112. Depending on an output of the wheel speed sensors 112 and/or depending on control commands of the control system 13, the brake cylinders 110 can be selectively supplied with compressed air from the air supply installation 40 via the rear axle modulator 114 and/or the front axle modulator 113 or vented via the rear axle modulator 114 and/or the front axle modulator 113.

FIG. 12 is a schematic representation of a motor vehicle 10 having a vehicle system including a pneumatic door sealing system 120. The pneumatic door seal system 120 has at least one seal 122, which can be provided, for example, for sealing along a vehicle door 121. The door seal 122 has a seal cavity 123. The seal cavity 123 may be formed in a first seal portion 125 of an elastically reversibly deformable material, which is best visible in the detail 124. The seal 120 may optionally have further seal portions, for example, one or more second seal portions 126 projecting resiliently from the first seal portion 125.

During operation, the control system 13 can selectively supply the door seal 122 with compressed air from the compressed gas tank 58 by controlling the pneumatic system 57 and/or the 2/2-way valve 71. Under the influence of the control system 13, the compressor 42 and the pneumatic system 71 and/or the 2/2-way valve 57 can be controlled such that sufficient gas pressure is available to inflate the seal 122, if this is required by the operating state of the vehicle.

FIG. 13 is a schematic representation of a motor vehicle 10 having a vehicle system including a pneumatic gear shift system 130. The pneumatic gear shift system 130 has a shift shaft 131 and several valves functionally coupled to this, which can include a 3/2-way valve 133, a 3/3-way valve 134 and/or a gas shut-off valve 132. At least some of the valves 133, 134 of the gear shift system 130 are supplied with compressed air, which has been dehumidified by the condensation cooler 41, via supply connections 135, which are connected to the compressed gas tank 58. Actuation of the controllable valves 133, 134 of the pneumatic gear shift system 130 can be performed automatically based on sensor output signals and/or in response to an actuation of a driver control element.

FIG. 14 is a schematic representation of a motor vehicle 10 having a vehicle system including a pneumatic locking system 140. The pneumatic locking system 140 can be configured as a pneumatic central locking system. The pneumatic locking system 140 has at least one pneumatic vehicle locking system 141. The pneumatic vehicle lock 141 has a locking mechanism 142 and a pneumatic actuating element, for example a compressed air piston 143, on. The compressed air piston 143 is set up to receive compressed air via the supply connection 73 and the controllable pneumatic system 71, which has been dehumidified by the condensation cooler 41. The supply of compressed air to the pneumatic actuating element 143 is carried out under control of the control system 13, for example in response to the detection of a key element and/or in response to a clamping signal or several clamping signals of the motor vehicle 10.

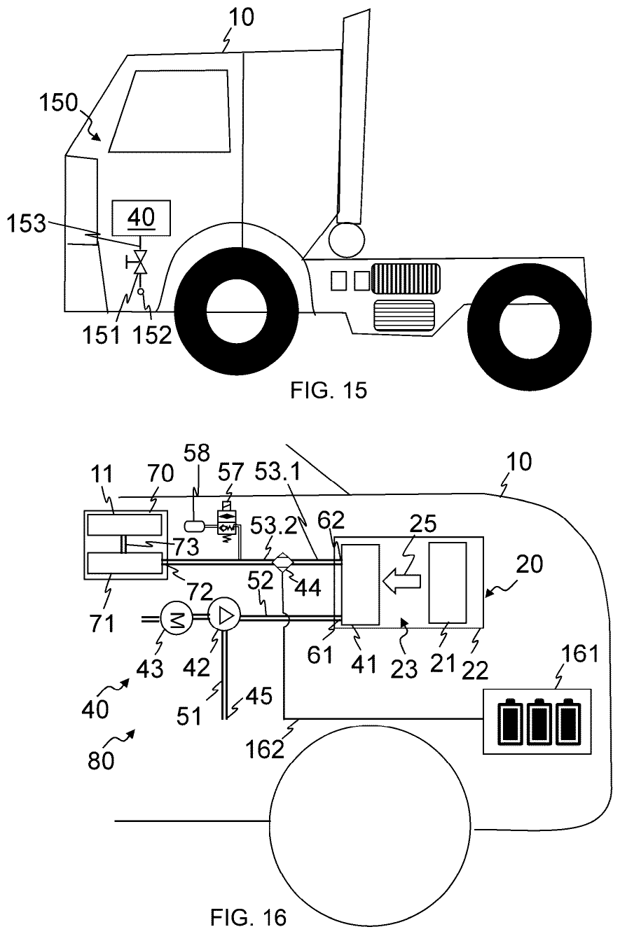

FIG. 15 is a schematic representation of a motor vehicle 10 having a vehicle system including a tire filling system 150. The tire filling system 150 may include a filling connection 152 for filling at least one tire and a controllable valve 151 which is set up to provide compressed air generated by actuation of the air supply installation 40 according to an embodiment via the filling connection 152.

As already explained, the different types of consumers, which have been described with reference to FIG. 9 to FIG. 15, can also be provided in combination. Accordingly, the motor vehicle 10 may include several different types of air consumers, as described in reference to FIG. 9 to FIG. 15, which can be supplied by compressed air generated by the air supply installation 40.

The air supply installation 40, the vehicle system 80 and the methods disclosed herein can also be advantageously used in particular if the adsorption dryer 44 is electrically regenerable. In this case, the dehumidification by the condensation cooler 41 extends the runtimes of the adsorption dryer 44 until a renewed regeneration. This reduces energy consumption. This increases the range of electric and hybrid vehicles.

FIG. 16 is a schematic representation of a motor vehicle 10 with the vehicle system 80 according to an embodiment. The vehicle system 80 may include any of the embodiments described with reference to FIG. 1 to FIG. 15. The motor vehicle 10 has a battery 161. The adsorption dryer 44 is electrically coupled to the battery 161 via an electrical connecting line 162. The electrical coupling may have controllable elements, in particular controllable switching elements, to selectively supply the adsorption dryer 44 with electrical energy from the battery 161. Regeneration of the adsorption dryer 44 can be carried out by drawing electrical energy from the battery 161.

The motor vehicle 10 may be an electric vehicle or hybrid vehicle. The battery 161 may have a traction battery. The dehumidification by the condensation cooler 41 extends the runtime of the adsorption dryer 44 until a renewed regeneration is necessary. This reduces energy consumption. This increases the range of electric and hybrid vehicles.

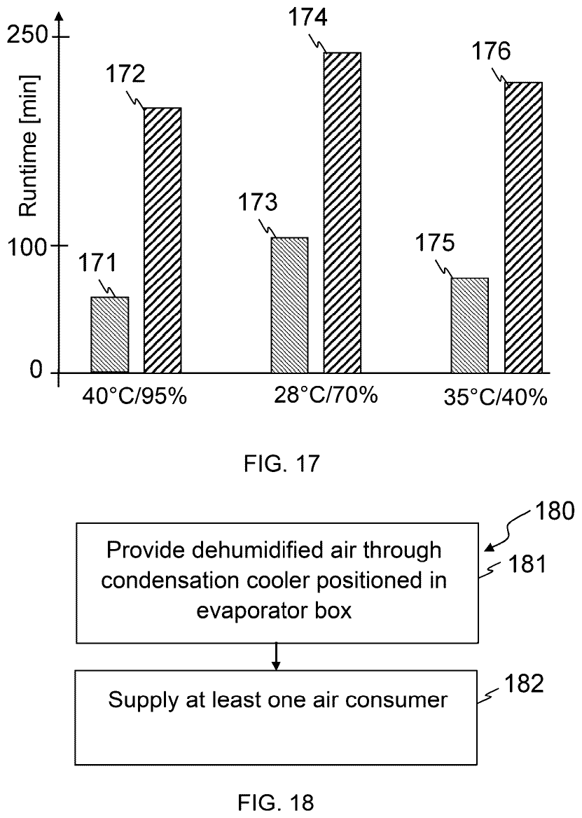

FIG. 17 is a representation of the runtimes of the adsorption dryer 44 with air intake of ambient air for different temperatures and different relative humidity values. FIG. 17 shows the runtime until a renewed regeneration is required. The data 171, 173, 175 represent the values for an air supply installation in which the condensation cooler is not positioned in the cold-air region of the air conditioning installation. The data 172, 174, 176 represent the values for an air supply installation according to an embodiment in which the condensation cooler is positioned in the evaporator box. The air supply installation thus extends the runtime of the adsorption dryer 44 until regeneration is necessary.

FIG. 18 is a flowchart of a method 180 according to an embodiment. The method 180 may be carried out using the air supply installation 40, the vehicle system 80, 90, 100, 110, 120, 130, 140, 150 or the motor vehicle 10 according to an embodiment. In step 181, dehumidified and cooled air is provided by a condensation cooler 41, which is positioned in an evaporator box 22 of an air conditioning installation 20. In step 182, the air is used to supply at least one air consumer. The method may include an intermediate storage of the air emitted by the condensation cooler 41 and/or further dehumidification of the air output by the condensation cooler 41. The method 180 may be used for extending a runtime of the adsorption dryer 44 and/or for increasing a range of the motor vehicle 10 including the air supply installation 40.

Air supply installations, vehicle systems, motor vehicles and methods according to embodiments have been described with reference to the FIGS.. Amendments and modifications can be realized in other embodiments.

Examples of further variations of the detailed disclosed embodiments include, for example, the following variations, without being limited thereto: The intake opening 45 may be arranged outside the evaporator box 22, whereby a transmission of noise from the air supply installation 40 into the vehicle interior 18 can be reduced. However, the intake opening 45 may also be positioned to suck in air from the air conditioning installation flow path. The intake opening 45 may be arranged in particular in the evaporator box 22 downstream of the air conditioning installation evaporator 21 (with respect to the air conditioning installation flow path in the direction of the vehicle interior 18). The air supply installation makes it possible to determine an intake point (that is, a position of the intake opening 45) from an acoustic point of view. While examples of vehicle systems with certain types of air consumers have been explained, the embodiments are not limited to this. The air supply installation can be used to supply additional air consumers, for example for lift axle systems.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

10 Motor vehicle
11 Air consumer
12 Vehicle sensor
13 Control system
14 Controllable vehicle component(s)
15 Wheel
16.1 Front axle
16.2 Rear axle
18 Vehicle interior
19 Ambient air
20 Air conditioning installation
21 Evaporator
22 Evaporator box
22.1 Evaporator box inlet
22.2 Evaporator box outlet
23 Air conditioning installation airflow path
23.1 First portion of the air conditioning installation airflow path
23.2 Second portion of the air conditioning installation airflow path
23.21-23.23 Part of the second portion of the air conditioning installation airflow path
24 Heater
25 Cold airflow
25.1 Temperature-controlled cold airflow
26 Air conditioning installation inlet airflow
27 Air conditioning installation fan
28 Air conditioning installation condenser
29 Air conditioning installation dehumidification tank
30 Additional air conditioning installation fan
31 Air conditioning installation regulating valve
32 Air conditioning installation compressor
33 First coolant line
34 Second coolant line
35 Third coolant line
36 Fourth coolant line
37 Fifth coolant line
38 Sixth coolant line
40 Air supply installation
41 Condensation cooler
42 Compressor
43 Drive
44 Adsorption dryer
45 Intake opening
51 Suction line
52 First connecting line
53 Second connecting line
53.1 Second connecting line
53.2 Third connecting line
53.3 Fourth connecting line
54.4 Fifth connecting line
54 Suction line
55 First connecting line
56 Second connecting line
57 2/2-way valve
59 Connection system
58 Compressed gas tank
60 Housing
61 First condensation cooler connection
62 Second condensation cooler connection
63 Condensation surface
63.1 Condensation cooler evaporator
64 Condensation cooler condenser
65 Condensation cooler control valve
66 Condensation cooler compressor
67 Water collecting tank with water discharge device
68 Condensation cooler fan
69.1 First condensation cooler line
69.2 Second condensation cooler line
70 Air consumer system
71 Controllable pneumatic system
71.1 Pneumatic module
72 Compressed air inlet
73 Feed connection
74 Control input
75 Control line
76 Controllable 2/2-way valve
80 Vehicle system
81 Condensation cooler inlet airflow
82 Condensation cooler outlet airflow
90 Sensor cleaning system
91 Nozzle
92 Actuator
93 Drive
94-96 Transmission paths
98 Directed airflow
100 Air suspension system
101 Air spring
102 Travel sensor
110 Brake system
111 Brake cylinder
112 Wheel speed sensor
113 Front axle modulator
114 Rear axle modulator
120 Pneumatic seal system
121 Vehicle door
122 Seal
123 Seal cavity
124 Detail
125 First seal portion
126 Second seal portion
130 Gear shift system
131 Shift shaft
132 Gas shut-off valve
133 3/2-way valve
134 3/3-way valve
135 Feed connection
140 Pneumatic locking system
141 Pneumatic vehicle locking
142 Locking mechanism
143 Compressed air piston
150 tire filling system
151 Controllable valve
152 Filling outlet
161 Battery unit
171-174 Runtime until regeneration
180 Method
181, 182 Method steps

1. An air supply installation for a motor vehicle having an air conditioning installation, wherein the air supply installation is for supplying at least one air consumer which is separate from the air conditioning installation, the air supply installation comprising:
an intake opening for suctioning in air;
a compressor for compressing the suctioned-in air;
a condensation cooler fluidically connected to said compressor; and,
said condensation cooler being arranged in a cold-air region of the air conditioning installation.

2. The air supply installation of claim 1, wherein said condensation cooler is arranged along a portion of an air conditioning installation airflow path which extends from an evaporator of the air conditioning installation to an interior of the motor vehicle.

3. The air supply installation of claim 2, wherein said condensation cooler is arranged such that cold air generated by the evaporator flows around or flows through said condensation cooler.

4. The air supply installation of claim 3, wherein said condensation cooler is configured to dehumidify an input airflow of said condensation cooler to provide an output airflow of said condensation cooler; and, the air supply installation further comprises an adsorption dryer configured to further dehumidify the output airflow of said condensation cooler.

5. The air supply installation of claim 2, wherein said condensation cooler is arranged along the air conditioning installation airflow path between the evaporator and a heater of the air conditioning installation.

6. The air supply installation of claim 2, wherein said condensation cooler is arranged along the air conditioning installation airflow path such that said condensation cooler is downstream of the evaporator and a heater of the air conditioning installation.

7. The air supply installation of claim 1, wherein said condensation cooler is arranged in an evaporator box of the air conditioning installation.

8. The air supply installation of claim 1 further comprising at least one pneumatic arrangement for conducting an output airflow of said condensation cooler to the at least one air consumer.

9. The air supply installation of claim 1, wherein said condensation cooler is arranged fluidically between said compressor and the at least one air consumer.

10. The air supply installation of claim 1, wherein said condensation cooler is arranged fluidically between said intake opening and said compressor.

11. A vehicle system for a motor vehicle having an air conditioning installation, the vehicle system comprising:
at least one air consumer separate from the air conditioning installation;
an air supply installation for supplying said at least one air consumer;
said air supply installation having an intake opening for suctioning in air, a compressor for compressing the suctioned-in air, and a condensation cooler fluidically connected to said compressor; and,
said condensation cooler being arranged in a cold-air region of the air conditioning installation.

12. The vehicle system of claim 11, wherein the vehicle system includes a sensor cleaning system, an air suspension system, a brake system, a gear shift system, a door seal system, a pneumatic locking system, or a tire filling system.

13. The vehicle system of claim 11 further comprising:
a vehicle sensor; and,
the vehicle system being configured to generate a directed cleaning airflow for cleaning said vehicle sensor.

14. The vehicle system of claim 13 further comprising an electronic control system coupled to an output of said vehicle sensor for controlling at least one controllable vehicle component.

15. The vehicle system of claim 11 further comprising:
said air conditioning installation; and,
said condensation cooler of said air supply installation being arranged in an evaporator box of said air conditioning installation.

16. A motor vehicle comprising the air supply installation of claim 1.

17. A motor vehicle comprising the vehicle system of claim 11.

18. A method for supplying at least one air consumer through an air supply installation of a motor vehicle, wherein the motor vehicle has an air conditioning installation, the at least one air consumer supplied by the air supply installation is separate from the air conditioning installation, the method comprising:
compressing suctioned-in air by a compressor of the air supply installation; and,
cooling and dehumidifying the suctioned-in air via a condensation cooler of the air supply installation, which is fluidically connected to the compressor, wherein the condensation cooler is arranged in a cold-air region of the air conditioning installation.

19. The method of claim 18, wherein the method is carried out with the air supply installation having an intake opening for suctioning in air, the compressor for compressing the suctioned-in air, and the condensation cooler fluidically connected to the compressor; and, the condensation cooler is arranged in the cold-air region of the air conditioning installation.

20. A method for reducing an energy consumption of an air supply installation of a motor vehicle having at least one air consumer, the method comprising:
supplying the at least one air consumer by the method of claim 18.

21. A method for increasing a range of a motor vehicle, the method comprising:
reducing the energy consumption of an air supply installation of the motor vehicle by the method of claim 20.

22. The method of claim 21, wherein the motor vehicle is an electric motor vehicle.
